(19) United States
(12) Patent Application Publication
(10) Pub. No.: US 2007/0022326 A1
(43) Pub. Date: Jan. 25, 2007

(54) Visual inspection of automatically-mounted component in circuit board assembly processes

(75) Inventors: Tin-Lup Wong, Chapel Hill, NC (US); Noboru Kodama, Yokohama (JP); Anthony Corkell, Cary, NC (US); Tadashi Kosuga, Shiga (JP)

Correspondence Address: LENOVO (US) IP Law, Mail Stop ZHHA/B675/PO Box 12195, 3039 Cornwallis Road, RTP, NC, 27709-2195, US

(73) Assignee: LENOVO (Singapore) Pte. Ltd., Singapore (SG)

(21) Appl. No.: 11/188,087

(22) Filed: Jul. 22, 2005

(51) Int. Cl. G06F 11/00

(52) U.S. Cl. 714/43

(57) ABSTRACT

A component is mounted onto a circuit board and is visually inspected after the circuit board is subjected to heat to determine whether the component has undergone a notable change in appearance. The component is preselected to have indicative characteristics after being subjected to heat. While the component is subjected to a predetermined temperature for less than a first duration of time, the component undergoes little or no change in appearance, and while subjected to the predetermined temperature for more than a second duration of time, the component undergoes a notable change in appearance. The circuit board is removed from a manufacturing process if the component has undergone a notable change in appearance.

### BACKGROUND of the INVENTION

This invention pertains to assembly processes and, particularly, to circuit board assembly processes involving the application of heat to a circuit board to induce solder reflow. More particularly, this invention pertains to circuit board assembly processes involving high temperature lead-free solder procedures. solder processes in electronic components is receiving increasing attention. Industry and regulatory action have taken place in response to this need. A European Council directive proposes restrictions on the use of lead among other materials in electronic products. The European Council has established target dates for a ban on hazardous materials including lead. The Japanese Ministry of International Trade has also set target dates and introduced legislation promoting the recycling of household electric appliances to reclaim all lead used starting in 2001. Household electric-appliance manufacturers are already working toward the creation of completely lead phase-out products. In the United States, the EPA announced a proposed rule to drastically lower reporting thresholds for lead and lead compounds to the Toxic Release Inventory from 10,000 lbs. to 10 lbs. As a result, lead is being phased out of electronic products. Specifically, lead is being replaced by other elements in solder alloys.

Lead has been an element used in solder alloys primarily because it reduces the melting temperature of the alloy, usually a tin/lead alloy. The temperature at which the solder melts is related to the solder reflow temperature used in solder reflow procedures. With the removal of lead from solder alloys, the melting/reflow temperature of the lead-free alloys will increase.

In transitioning to lead-free soldering processes for electronic products, the solder-process temperatures have increased due to the higher melting point of the new solder systems. Whereas, typically, tin-lead (Sn—Pb) alloys melt at 183 degrees C., the new alloys melt in the range of about 200-240 degrees C. The increased temperatures apply to surface mount component-reflow processes, which typically involve an oven for applying heat, and as well to the traditional wave solder reflow processes. In the case of oven heating, a populated circuit board is exposed to heat in the form of infrared (IR) energy for a predetermined amount of time. This exposure to heat for a given amount of time is known as a heat cycle.

Table 1 is a partial list of leaded and lead-free solder systems.

TABLE 1

| Solder | Melting Temperature | Max. Temperature |
|---|---|---|
| Composition | (° C.) | (° C.) |
| Sn—Pb | 183 | 220-230 |
| Sn—Ag—Cu | 216-227 | 250-260 |
| Sn—Ag—Bi—Cu | 214-217 | 250-260 |

As it affects the individual components on the circuit board, the maximum temperature experienced during the heat cycle has an effect on component reliability. Most of the components used in the new high temperature processes have a specified maximum temperature of 260 degrees C. for a maximum of 10 seconds. However, in order to make sure that the coldest solder joint reaches the reflow temperature, some areas on the circuit board will exceed a temperature of 250 degrees C. This does not allow much in the way of margin for the components thus specified. For a lead-free process, tighter process control is required to make reliable products. For example, a five-oven-zone temperature control is required vs. a traditional three-zone control.

On the other hand, under heating can also be a problem. If the process temperature is not set to the higher temperature to ensure lead-free reflow, a circuit board component can become detached during actual use in a customer environment. Therefore, the process profile has to be tightly controlled for both temperature and time duration.

Currently, when a circuit board comes out of an IR-reflow oven, there is no cost-effective way to determine which temperature extremes were experienced by the circuit board during the reflow process. An extant process deviation which results in overheating or under heating results in a problematic situation because the deviation goes largely undetected except during extreme deviations. Undetected process deviations will have an adverse effect on the reliability of the products.

### SUMMARY of the INVENTION

It has been discovered that one or more of certain components can be placed on the circuit board which exhibit visible phenomenon, or not, at threshold temperatures of interest after being subjected to those temperatures for a specified amount of time. For example, and not by way of limitation, one or more extra surface mount components, which if destroyed in the process are considered to be sacrificial components, are mounted on the circuit board to serve as a visible indicator of the heat cycle (temperature over a period of time) to which the component or circuit board was exposed. It has been discovered that these components are useful in at least processes herein described. A single threshold temperature of interest or multiple threshold temperatures of interest can be targeted with one or more of such components to give visual indication of the process temperature being too low, within tolerances, and/or too high.

According to one aspect of the present invention, a method comprises mounting a component onto a circuit board using an automated mounting process such as, for example, a surface-mount soldering process, which may be used for a majority of components on the circuit board. The circuit board is subjected to heat which may be applied by means of an oven or the like. One characteristic of the mounted component is that while the component is subjected to a first predetermined temperature for less than a first duration of time, the component undergoes one of an insignificant or no change in appearance, and while subjected to the first predetermined temperature for more than a second duration of time, undergoes a notable change in appearance. The method further includes visually inspecting the component and determining, based on the visual inspection, whether the component has undergone a notable change in appearance. If the component has undergone a notable change in appearance, the circuit board is removed from a manufacturing process.

The first and second time durations may be of the same or different duration. As an example of differing durations, the component may be subjected to a temperature of 250 degrees C. for less than 10 seconds and exhibit little or no change in appearance; yet, when the component is subjected to the same temperature for more than 15 seconds, the component will exhibit a notable change in appearance. As a same-duration example, the component may be subjected to a temperature of 250 degrees C. for less than 10 seconds and exhibit little or no change in appearance; yet, when the component is subjected to the same temperature for more than 10 seconds, the component will exhibit a notable change in appearance.

A second component may also be mounted which undergoes a notable change in appearance when subjected to the first temperature for a longer or a shorter period of time than the second period of time. This optionally allows for indication of how long the first predetermined temperature is extant. Accordingly, a second component may be mounted onto the circuit board using the automated mounting process. While this second component is subjected to the first predetermined temperature for less than a third duration of time, it undergoes little or no change in appearance. Yet, while the second component is subjected to the first predetermined temperature for more than a fourth duration of time which is greater than the second duration of time, it undergoes a notable change in appearance. The first and third durations of time may be of the same, or different, duration. The visual inspection of this embodiment further includes inspection of the second component, and the determination is further based on whether the second component has undergone a notable change in appearance. Additional components may thus be added.

According to one aspect of the present invention, a method comprises the mounting of a component onto a circuit board using an automated mounting process. The circuit board is subjected to heat. The mounted component comprises a primary electrical function which is other than thermal indication, time indication, and combinations thereof. For example, the mounted component can be a standard surface mount component such as an LED, resistor, capacitor, or logic date, but neither a thermal fuse nor a device which primarily indicates the elapse time since a predetermined event. An additional characteristic of the mounted component is that while the component is subjected to a first predetermined temperature for less than a first duration of time, the component undergoes one of an insignificant or no change in appearance, and while subjected to the first predetermined temperature for more than a second duration of time, undergoes a notable change in appearance. The method further includes visually inspecting the component and determining, based on the visual inspection, whether the component has undergone a notable change in appearance. If the component has undergone a notable change in appearance, the circuit board is removed from a manufacturing process. For example, if the visual inspection indicates a notable change, the circuit board can be removed from final assembly or testing.

In one embodiment, the primary electrical function of the component is unused. For example, where the component is an LED and the primary electrical function is to therefore emit light, the LED may be intended as a sacrificial part and is, accordingly, not wired to any energizing drivers or the like. Thus, in this example, should the circuit board pass final testing and form a component of a system, when in operation, the LED is not used for emitting light.

According to one aspect of the present invention, a method includes the mounting of a first component onto a circuit board using an automated mounting process. A characteristic of the first component is that while subjected to a first predetermined temperature for less than a first duration of time, it undergoes one of an insignificant or no change in appearance. While subjected to the first predetermined temperature for more than the first duration of time, it undergoes a notable change in appearance. The method further includes a mounting of a second component onto the circuit board. A characteristic of the second component is that while subjected to a second predetermined temperature for less than a second duration of time, it undergoes one of an insignificant or no change in appearance; while subjected to the second predetermined temperature for more than the second duration of time, it undergoes a notable change in appearance. In this embodiment, the second temperature is less than the first temperature. The circuit board is heated and the first and second components are visually inspected. Determinations are made based on the visual inspection. A determination (a) is made as to whether the first component has undergone a notable change in appearance. A determination (b) is made as to whether the second component has undergone a notable change in appearance.

The first and second time durations may be of the same or different duration, although, here, the first and second designations have a different application. As an example of differing durations, for this embodiment, the first component may be subjected to a temperature of 250 degrees C. for less than 10 seconds and exhibit little or no change in appearance, and when subjected to 250 degrees C. for more than 10 seconds, the first component will exhibit a notable change in appearance. Meanwhile, for example and not by way of limitation, depending on the placement on the circuit board, should the second component experience a lower temperature of 230 degrees C. for less than 15 seconds it will exhibit little or no change in appearance, and when subjected to 230 degrees C. for more than 15 seconds, the second component will exhibit a notable change in appearance. As a same-duration example, both parts may transition after 10 seconds to a notable appearance at 250 degrees C. and 230 degrees C. respectfully.

According to one embodiment of this aspect of the invention, the circuit board is removed from a manufacturing process based upon a determination (a) that the first component has undergone a notable change in appearance.

According to one embodiment of this aspect, the circuit board is removed from a manufacturing process based upon a determination (a) that the first component has undergone a notable change in appearance and a determination (b) that the second component has undergone a notable change in appearance.

According to one embodiment of this aspect, the circuit board is removed from a manufacturing process based upon a determination (b) that the second component has not undergone a notable change in appearance.

According to one embodiment of this aspect, the circuit board is removed from a manufacturing process based upon a determination (a) that the first component has not undergone a notable change in appearance and a determination (b) that the second component has not undergone a notable change in appearance.

According to one embodiment of this aspect, the circuit board is included in a manufacturing process based upon a determination (a) that the first component has not undergone a notable change in appearance and a determination (b) that the second component has undergone a notable change in appearance. As an example of inclusion into a manufacturing process, the circuit board can be forwarded to a final assembly process where it is determined that the first component has not undergone a notable change in appearance and that the second component has undergone a notable change.

### DETAILED DESCRIPTION of the ILLUSTRATIVE EMBODIMENTS

While the present invention will be described more fully hereinafter, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

It has been discovered that certain components exhibit properties which are useful in at least the manufacture of circuit boards. These components degrade gradually when exposed to heat at repeatable predetermined temperature thresholds and exhibit visible changes after experiencing the heat for a predetermined amount of time. Yet, these components are able to exhibit little or no change in visual appearance when subjected to the predetermined temperature for less than a same or different predetermined amount of time. In addition, the one or more extra components used in the embodiments are preferably surface mount components which can be mounted using the same automated process as is used for the majority of circuits on the board. That is, they can be installed by the same high-speed insertion machines used by manufacturers during the mounting process. Thus, no new machines, tools, or tooling need be introduced to implement the embodiments.

During the lead-free transition, there are at least two issues which the embodiments address. The first issue is where components on the circuit board are exposed to exceedingly high temperatures for too long a period of time. The second issue is where the IR reflow temperature is not correctly set to the higher temperature required for the lead-free process.

In a lead-free transition study, it has been discovered that many components show visible signs of breakdown and may not survive after being exposed to 260 degrees C. for more than 10 seconds. The embodiments make use of these and similar properties and include components or parts to be installed on a circuit board at strategic locations for surface-mount-process confirmation and monitoring. These components may be considered extra components or sacrificial components since, according to the preferred embodiment, the parts are left unwired or otherwise unused and are not intended to function electrically. Whether the component actually survives the heat cycle, or not, is not of interest since the primary electrical function of the component is preferably unused. The following table includes a partial list of industry standard components which may be used in the embodiments and which represent examples of such components.

TABLE 2

| | | | | Effects of |
|---|---|---|---|---|
| | | Exceeded | Exceeded | Exceeding |
| Part | Maker/ | Temp. | Time | Temperature for |
| Number | Catalog | (° C.) | (Seconds) | Specified Time |
| 91P9300 | Foxconn CPU | 255 +/− 5 | 6 | Blister/Warpage |
| | Socket | | | |
| 77P0555 | Agilent 4 Mbps | 220 | 70 | Blister on body/ |
| | IRDA Module | | | Wire bond open |

The components listed in Table 2 show blistering and other effects when subjected to the specified temperatures for over the specified time. These same components, however, would show little or no effect if subjected to a lower temperature for an even greater amount of time, or, as can be expected, for a lesser amount of time. For example, it is predicted that the Agilent module shown in Table 2 should be able to endure a temperature of 170 degrees C. for more than 200 seconds.

Also, it is considered to be unlikely that the Agilent part will show any visible signs of blistering after 15 seconds of exposure to a temperature of 220 degrees C. Likewise, the Foxconn CPU socket is unlikely to blister or warp when subjected to a temperature of 255 degrees C. for only three seconds. As such, these components are components which while subjected to a predetermined temperature for less than a first duration of time, undergo little or no change in appearance, and while subjected to the predetermined temperature for more than a second duration of time, undergo a notable change in appearance. The second duration of time is usually longer than the first duration of time and may be of the same duration. Accordingly, it is envisaged that it is possible to identify and utilize a part which exhibits little or no change in appearance when subjected to 220 degrees C. for less than five seconds and shows a notable change in appearance when subjected to the same temperature for more than five seconds.

Note, also, that these components preferably have a primary electrical function which is other than a thermal indication function, a time indication function, and a thermal-time indication function. For the sake of convenience, these components will be herein referred to as monitoring components.

The various embodiments of the present invention provide a quality metric for circuit board manufacturing processes involving high-temperature solder reflow. The embodiments include mounting monitoring components onto a circuit board. Although one or more monitoring components may be placed anywhere on the circuit board, they may be placed according to predictable criteria. Presumably, the heat applied during the heat cycle may not be uniform across the circuit board. Where there are certain areas of the board which are considered to be likely hot spots, for example the edges of the board, monitoring components may be placed there. Additionally, some parts have more thermal capacity, for example due to a higher mass. In general, it is desirable to have the coolest solder joints across the entire area of the board while at the same time reaching the reflow temperature so that all joints solder properly. However, if one part is known to have a higher thermal capacity, then for that part to reach the reflow temperature, the rest of the circuit board parts may have to be exposed to higher temperatures and for a longer duration of time. Placement can be predicted from each part's specification. Where there are parts that are known to have marginal heat-time duration specs, monitoring components can be placed near or surrounding such parts.

In a preferred embodiment, two surface-mount monitoring components are to be mounted onto a circuit board near a part having high thermal capacity using well-known high-speed surface-mount insertion machines. One of the monitoring components is to be preselected to show the types of visible signs described above (e.g., blistering) after six seconds at 250 degrees C. and the other is to be preselected to show visible signs after nine seconds at 230 degrees C. The circuit board is to be heated in an IR oven to induce solder reflow. The target temperature of the heat cycle is to be 240 degrees C. for a Sn—Ag—Cu solder composition. The circuit board is to then be visually inspected. Upon visual inspection, the 230-degree component is expected to give an indication that the heat cycle reached a minimum heat cycle specification of 230 degrees C. for at least nine seconds; the 250-degree component is expected to give an indication that the heat cycle did not surpass the maximum heat cycle specification of 250 degrees C. for more than six seconds.

The monitoring components may be preselected to endure those temperatures for time durations which are less than six and nine seconds respectively, for example, two and five seconds respectively, and show little or no change in appearance, e.g., blistering. The monitoring components may be preselected to be able to be subjected to a cooler-preheat cycle, say at 200 degrees C., for an extended period of time, for example, one minute, and also show little or no change in appearance. Alternatively, it is envisaged that both components may be preselected to transition after six seconds at their respective temperatures of 250 and 230 degrees C.

Determinations are then to be made, for each component, as to whether the first and second components have undergone a notable change in appearance, such as blistering. In the case that the 230-degree component doesn't show blistering, it can be presumed that the minimum heat cycle specification has not been reached. Where the 230-degree component shows blistering, it can be presumed that the minimum heat cycle specification has been reached. In the case that the 250-degree component doesn't show blistering, it can be presumed that the maximum heat cycle specification has not been exceeded. Where the 250-degree component shows blistering, it may be presumed that the maximum heat cycle specification has been exceeded.

In one embodiment, if the 250-degree component or both monitoring components show blistering, it may be presumed that the heat cycle was too intensive. In this case, the circuit board can be rejected and removed from a manufacturing process such as final testing or product assembly.

In one embodiment, if the 230-degree component or neither of the monitoring components show blistering, it may be presumed that the heat cycle was of inadequate intensity. In this case, the circuit board can likewise be rejected and removed from a manufacturing process.

In one embodiment, if the 230-degree component shows blistering (confirming that the minimum heat cycle specification was met) and the 250-degree component does not show blistering (confirming that the maximum heat cycle specification was not exceeded), it may be presumed that the heat cycle was adequate and to specification. In this case, the circuit board may be included in a manufacturing process. For example, due to a successful visual inspection, the circuit board can be passed to final testing and final assembly.

Other embodiments are possible. One embodiment is to include multiple components for process confirmation and/or over-temperature monitoring. For example, three components may be mounted on the board: one which can survive a maximal temperature of interest of say, 260 degrees C. for five seconds, one which can survive 260 degrees C. for 10 seconds, and one which can survive for 260 degrees C. for 15 seconds. These components can then be visually inspected and determinations similarly made as to what temperature excursion the circuit board has experienced, i.e., how high of a temperature and for how long.

The order of steps given herein is for exemplary purposes only and should not be interpreted as limiting with respect to other embodiments which are possible using a different order of steps in implementing the inventive concepts described herein. Any lettering or numbering of steps in the claims is for the purpose of improving clarity and does not imply any particular order of steps to be taken. Similarly, terms such as “a first step” and “a second step” are used to establish antecedent basis for these terms and do not necessarily imply any particular order or value.

There has been set forth a preferred embodiment of the invention and, although specific terms are used, the description thus given uses terminology in a generic and descriptive sense only and not for purposes of limitation.

What is claimed is:

1. A method comprising:
mounting a first component onto a circuit board using an automated mounting process, wherein the first component, while subjected to a predetermined temperature for less than a first duration of time, undergoes one of an insignificant or no change in appearance, and while subjected to the predetermined temperature for more than a second duration of time, undergoes a notable change in appearance;
heating the circuit board;
visually inspecting the first component;
determining, based on said visual inspection, whether the first component has undergone a notable change in appearance; and
removing the circuit board from a manufacturing process based upon said determination.

2. The method of claim 1 wherein the first duration of time and the second duration of time are of a same duration.

3. The method of claim 1 wherein the automated mounting process is a process which is used for a majority of components on the circuit board.

4. The method of claim 1, further comprising:
mounting a second component onto the circuit board using the automated mounting process, wherein the second component, while subjected to the predetermined temperature for less than a third duration of time, undergoes one of an insignificant or no change in appearance, and while subjected to the predetermined temperature for more than a fourth duration of time which is greater than the second duration of time, undergoes a notable change in appearance;
wherein,
said visual inspection further includes inspection of the second component, and
said determination is further based on whether the second component has undergone a notable change in appearance.

5. The method of claim 4 wherein the first duration of time and the third duration of time are of a same duration.

6. A method comprising:
mounting a component onto a circuit board using an automated mounting process, wherein the component, while subjected to a predetermined temperature for less than a first duration of time, undergoes one of an insignificant or no change in appearance, and while subjected to the predetermined temperature for more than a second duration of time, undergoes a notable change in appearance, and wherein the component comprises a primary electrical function which is other than a function selected from the group consisting of thermal indication, time indication, and combinations thereof,
heating the circuit board;
visually inspecting the component;
determining, based on said visual inspection, whether the component has undergone a notable change in appearance; and
removing the circuit board from a manufacturing process based upon said determination that the component has undergone a notable change in appearance.

7. The method of claim 6 wherein the primary electrical function of the component is unused.

8. The method of claim 6 wherein the first duration of time and the second duration of time are of a same duration.

9. The method of claim 6 wherein the automated mounting process is a process which is used for a majority of components on the circuit board.

10. A method comprising:
mounting a first component onto a circuit board using an automated mounting process, wherein the first component, while subjected to a first predetermined temperature for less than a first duration of time, undergoes one of an insignificant or no change in appearance, and while subjected to the first predetermined temperature for more than the first duration of time, undergoes a notable change in appearance;
mounting a second component onto the circuit board using an automated mounting process, wherein the second component, while subjected to a second predetermined temperature for less than a second duration of time, undergoes one of an insignificant or no change in appearance, and while subjected to the second predetermined temperature for more than the second duration of time, undergoes a notable change in appearance, wherein the second temperature is less than the first temperature;
heating the circuit board;
visually inspecting the first and second components; and
(a) determining, based on said visual inspection, whether the first component has undergone a notable change in appearance; and
(b) determining, based on said visual inspection, whether the second component has undergone a notable change in appearance.

11. The method of claim 10, further comprising:
removing the circuit board from a manufacturing process based upon said determination (a) that the first component has undergone a notable change in appearance and said determination (b) that the second component has undergone a notable change in appearance.

12. The method of claim 10, further comprising:
removing the circuit board from a manufacturing process based upon said determination (a) that the first component has not undergone a notable change in appearance and said determination (b) that the second component has not undergone a notable change in appearance.

13. The method of claim 10, further comprising:
including the circuit board in a manufacturing process based upon said determination (a) that the first component has not undergone a notable change in appearance and said determination (b) that the second component has undergone a notable change in appearance.

14. The method of claim 10 wherein the first duration of time and the second duration of time are of a same duration.

15. The method of claim 10 wherein the automated mounting process is a process which is used for a majority of components on the circuit board.

16. A method comprising:
mounting a first component onto a circuit board using an automated mounting process, wherein the first component, while subjected to a first predetermined temperature for less than a first duration of time, undergoes one of an insignificant or no change in appearance, and while subjected to the first predetermined temperature for more than a second duration of time, undergoes a notable change in appearance, and wherein the first component comprises a primary electrical function which is other than a function selected from the group consisting of thermal indication, time indication, and combinations thereof;
mounting a second component onto the circuit board using an automated mounting process, wherein the second component, while subjected to a second predetermined temperature for less than a third duration of time, undergoes one of an insignificant or no change in appearance, and while subjected to the second predetermined temperature for more than a fourth duration of time, undergoes a notable change in appearance, wherein the second temperature is less than the first temperature;
heating the circuit board;
visually inspecting the first and second components; and
(a) determining, based on said visual inspection, whether the first component has undergone a notable change in appearance; and
(b) determining, based on said visual inspection, whether the second component has undergone a notable change in appearance.

17. The method of claim 16 wherein the primary electrical function of the component is unused.

18. The method of claim 16, further comprising:
removing the circuit board from a manufacturing process based upon said determination (a) that the first component has undergone a notable change in appearance.

19. The method of claim 16, further comprising:
removing the circuit board from a manufacturing process based upon said determination (a) that the first component has undergone a notable change in appearance and said determination (b) that the second component has undergone a notable change in appearance.

20. The method of claim 16, further comprising:
removing the circuit board from a manufacturing process based upon said determination (b) that the second component has not undergone a notable change in appearance.

21. The method of claim 16, further comprising:
removing the circuit board from a manufacturing process based upon said determination (a) that the first component has not undergone a notable change in appearance and said determination (b) that the second component has not undergone a notable change in appearance.

22. The method of claim 16, further comprising:
including the circuit board in a manufacturing process based upon said determination (a) that the first component has not undergone a notable change in appearance and said determination (b) that the second component has undergone a notable change in appearance.

23. The method of claim 16 wherein the first, second, third, and fourth durations of time are of a same duration.

24. The method of claim 16 wherein the automated mounting process is a process which is used for a majority of components on the circuit board.
